(19) United States
(12) Patent Application Publication
(10) Pub. No.: US 2014/0221535 A1
(43) Pub. Date: Aug. 7, 2014

(54) Tire Sealant and Preparation Method Thereof

(71) Applicant: TOP ALLIANCE TECHNOLOGY LIMITED, Tortola (VG)

(72) Inventors: Wai Ming Chan, New Territories (HK); Koon Fung Lam, New Territories (HK)

(73) Assignee: Top Alliance Technology Limited, Tortola (VG)

(21) Appl. No.: 13/760,122

(22) Filed: Feb. 6, 2013

(51) Int. Cl. B29C 73/16

(52) U.S. Cl. CPC B29C 73/163
USPC 524/29; 524/557; 524/388

(57) ABSTRACT

The present invention discloses a tire sealant and a preparation method thereof. The tire sealant comprises a solvent of 35%-95%, PVA gel of 0.05%-10%, block particles of 0.01%-5% and an additive of 0.1%-10%. The tire sealant can also comprise chitosan gel of 0.01%-5%. The method comprises the following steps: S1. polymer material particles are dissolved and precipitation is controlled to form suspended gel material in a liquid medium; S2. An additive is added into the liquid medium; and S3. block particles are added into the liquid medium containing the suspended gel material. When using the tire sealant and its preparation method in the present invention, the puncture formed by a spike with a diameter equal to or less than 6.35 mm can be sealed. Besides, the broken hole can be repaired between −40□ and 70□, and the sealing time can last for more than 48 hours.

### FIELD OF THE INVENTION

The present invention relates to a tire sealant and a preparation method thereof. In particular, the present invention relates to a tire sealant in direct connection to a valve core and a preparation method thereof

### BACKGROUND OF THE INVENTION

Tires are important components for automobiles. A puncture to the tire during a driving process of automobiles is a potential risk to a driver, particularly when the driver is driving on a highway or a motorway. Besides, the driver may be subjected to any other danger when he/she tries to replace or repair the tire on the highway.

To ensure the tire to be functioned normally, a tire sealant which is a liquid product can be applied to play a role of sealing the hole on the tire temporarily. Besides, the technology to repair the hole by means of such tire sealant has developed for decades. Briefly speaking, the tire sealant is typically composed of sealing material, tackifier and solvent with anti-freezing agent. Some common components influencing the sealing performance such as ethylene glycol and propylene glycol are also included as the necessary components to reduce a freezing point of the tire sealant, so that the tire sealant can play its role at low temperature environment.

Although the latex-based tire sealant is one of the most common sealing materials, there are still many drawbacks for this kind of latex-based tire sealant, which include disposal difficulty, cleaning and washing problems for the residue on the tire, any other issues about noxious gas and environment in relation to the latex-based tire sealant. Therefore, the tire sealant based on the absence of latex has gradually developed recently.

One substitute product for latex-based tire sealant is polyvinyl alcohol (PVA). For instance, US Patent No. 20100222255 disclosed a tire sealant with 0.15% of PVA, while US Pat. No. 4,101,494 also took the PVA as one of the components during the preparation of tire sealant. In addition, PVA can also act as an emulsifying and dispersing agent. Another advantage of using PVA lies in that it brings convenience for cleaning. However, asbestos is included as a component of the tire sealant disclosed in such patents, thereby resulting in great toxicity to the tire sealant.

Below some methods for repairing a puncture are stated in brief. As described in U.S. Pat. No. 4,101,494, when a puncture is present on the tire, various fibers of the tire sealant at or near the puncture are forced to pass through the puncture. Due to the PVA or absorbate on the fibers, the purpose of repairing the hole is achieved. In spite of this, another function of PVA by making use of its water soluble nature is described in U.S. Pat. No. 6,506,273. During the repair of the tire puncture, a water soluble bag made of PVA and possessed of substances for sealing is inserted between a tire bead and a gap of a rim. In this way, such substances functioning for sealing then seals the puncture when water is injected and the bag made of PVA is dissolved. However, the tire sealant disclosed in this patent is free of PVA, as a result of which the tire sealant is still difficult to clean.

In US Patent No. 20030230369, a tire in which the PVA is functioned as self-sealing is also described. Indeed, a PVA layer is coated on the tire during tire manufacture to prevent the tire from any puncture or damage in the process of transportation. Nevertheless, the PVA in this patent is permanently attached on an inner wall of the tire in fixed quantity. As a result, if the tire attached with the PVA is punctured, it cannot be repaired in time by usage of the tire sealant.

### SUMMARY OF THE INVENTION

The technical problem to be solved in the present invention is to provide a tire sealant and a preparation method thereof Wherein such tire sealant is environment protective, non-toxic, effective and easy in cleaning and application, aiming at the above-mentioned drawbacks that the tire sealant in the prior art is difficult in cleaning, harmful to environment and complex in the sealing method.

The technical solution adopted to solve the technical problem in the present invention is as follows: a tire sealant is provided, which includes 35%-95% of solvent, 0.05%-15% of gel, 0.1%-5% of block particles and 0.01%-10% of additive.

Advantageously, the gel is comprised of 0.01%-5% of chitosan gel and 0.05%-10% of polyvinyl alcohol gel.

Advantageously, the solvent is comprised of 10%-60% of water and 25%-95% of anti-freezing agent.

Advantageously, the anti-freezing agent comprises at least one of propylene glycol, glycerin, calcium and magnesium chloride.

Advantageously, the block particles comprise at least one of chitosan material, kaolinite, silicon dioxide, wollastonite, diatomite, mica, mesoporous silicon dioxide and colloidal silicon dioxide.

Advantageously, a range for particle size of the block particles is 0.1-350 micron.

Advantageously, the additive comprises tackifer, preservative, antirusting agent, antifoaming agent, curing agent, colorant and antioxidant.

In another technical solution of the present invention, a method for preparing a tire sealant is provided, wherein comprising the following steps:
S1. Dissolving polymer material particles and controlling precipitation to form suspended gel material in a liquid medium;
S2. Adding an additive into the liquid medium;
S3. Adding block particles into the liquid medium which contains the suspended gel material.

Advantageously, the step S1 comprises a step S1a: dissolving polyvinyl alcohol and a proper amount of surfactant into hot water, and then heating the hot water for a long time so as to prepare polyvinyl alcohol gel.

Advantageously, the step S1 comprises a step S1b: dissolving polyvinyl alcohol into hot water completely, and then adding a proper amount of additive to prepare polyvinyl alcohol gel.

When implementing the tire sealant and its preparation method in the present invention, there is no need to remove the valve core before injecting the tire sealant, and the hole foamed by a spike with a diameter smaller than or equal to 6.35 mm can be repaired between −40□ and 70□ in a few seconds. Besides, the sealing can last for more than 48 hours, only little precipitation is formed when the tire sealant is left for more than one week, and the tire sealant which is environmental protective and non-toxic can be easily cleaned by water after its application

### DETAILED DESCRIPTION OF THE PREFERRED EMBODIMENT

The present invention discloses a new formula of tire sealant depending on log-jam principle. This formula is characterized as being environmentally friendly, safe, non-toxic, user-friendly, odourless and high sealing effect. The tire sealant of the present invention functions by a log-jamming effect of some rigid material at the puncture. Herein, the particles of the rigid material operable to block the puncture or the hole are referred to as block particles. Meanwhile, gel material prepared from PVA and/or chitosan enhances the sealing ability and stability of the tire sealant. The puncture size that can be sealed by the tire sealant depends on the size of the block particles and the weight percentage of each solid content in the tire sealant. In the present invention, the puncture formed by a spike with a diameter of at least 6.35 mm can be sealed by such tire sealant. The tire sealant herein is a valve core through type; that is, it can be applied into the puncture conveniently without removing the valve core before injection. The tire sealant functions well between −40□ and 70□, and its sealing performance can maintain for 48 hours or even more, which is up to the specific sealant composition. The injected tire sealant can be easily cleaned up by water after its application and the odour of the tire sealant is non-toxic.

A preferred tire sealant comprises of semi-dissolved polymer material. PVA polymer can be transformed from its original hard, rigid nature to gel-like, semi-transparent and flexible PVA gel. The PVA gel makes preparation for achieving excellent sealing performance for the tire sealant. The presence of tackifier can control the viscosity of the solution and enhance the stickiness of the rigid and flexible suspended solid so that it is closely attached onto the puncture wall. In addition, anti-freezing agents with low toxicity such as propylene glycol, glycerol, calcium and magnesium chloride are used to decrease the freezing point of the aqueous liquid tire sealant in order to widen its operating temperature for tire sealing. Other additives such as preservative, anti-corrosion agent, anti-foaming agent, curing agent and colorant are preferably added into the tire sealant to improve its shelf-life and appearance.

A tire sealant according to the present invention consists of liquid and solid components, wherein the liquid one acts as the solvent to carry the solid one.

The liquid component comprises water and an anti-freezing agent which is used to lower the freezing point of the tire sealant. Tackifier is also included in the tire sealant; herein it operates to control the viscosity of the solution and enhance the stickiness of the rigid and flexible suspended solid so that it is closely attached onto the puncture wall. An anti-corrosion additive is added into the tire sealant to prevent any metal portion of the tire from rusting. Besides, preservative may also be added to extend the shelf-life of the tire sealant. Moreover, other odoring and coloring additives may also be added optionally to improve the physical properties of the tire sealant.

The freezing point of the resulting tire sealant can be decreased with the usage of the anti-freezing agent. Herein, the best effect is achieved by propylene glycol and glycerin. The anti-freezing agent widens the operating temperature of the tire sealing at low temperature condition. In a preferred embodiment, the tire sealant comprises of 25%-90% of propylene glycol and 0%-70% of glycerin. The resulting tire sealant thereafter has a freezing point of −40□. In addition, some salts such as calcium chloride and magnesium chloride can also be added into the preferred composition optionally as the inorganic anti-freezing agent.

In the preferred embodiment, 0.01%-5% of anti-foaming agent is added into the tire sealant in order to reduce any foam formed during the production process and prevent the occurrence of rusting inside the tire respectively.

The water content of the tire sealant is 10%-60%. It provides a medium for suspending the soft gel chitosan, the PVA gel particle and any other rigid particles (i.e. block particles) and for dissolving various additives added optionally.

The main solid components in the tire sealant of the present invention are flexible and soft suspended materials which can be produced from water soluble polymer and/or natural materials via any appropriate physical or chemical method. Various solid and rigid particles such as mica are optionally added to reinforce the sealing performance of the tire sealant. Zinc oxide or titanium oxide is added to prevent the tire sealant from decomposition under sunlight exposure.

In this preferred embodiment, polyvinyl alcohol (PVA) is used as the strengthening and toughening gel for sealing purpose. PVA is prepared through a polymerization reaction of vinyl acetate followed by partial hydrolysis, precipitation, washing and drying. Indeed, there are different methods to prepare the flexible PVA structure for tire sealant application.

The first method is to partially dissolve the PVA in hot water with appropriate surfactant. Instead of maintaining to be hard and rigid particles, a semi-dissolved PVA is replaced to be gel-like, semi-transparent, elastic and tough, which also suspends in the liquid medium. The specific size of the gel particle depends on the type and molecular weight of PVA, the ratio of PVA and surfactant, a heating temperature and time. Regarding the combined sealing mechanism mentioned above, other polymeric materials that can be prepared to be gel-like particles in the given liquid medium are also suitable for preparing the tire sealant in addition to PVA.

Another method to prepare the gel is to firstly dissolve the PVA in hot water completely, which is followed by adding some additives such as sodium silicate or sodium borax. The additives react with the PVA to form flexible and tough gel. The specific size of the gel particle depends on the type and molecular weight of PVA, usage amount of additives, temperature, pH value and sequence of chemical mixing. Furthermore, the resulting gel-like structure can be decomposed under the exertion of shearing force.

In the preferred embodiment, the tire sealant prepared in the first method comprises of 0.05%-10% of PVA gel which functions as an essential sealing component. It is prepared by dissolving 0.05%40% of PVA and 0.001%-5% of sodium dodecyl sulfate (SDS) in hot water at a temperature range of 30-100° C. and then heating the hot water for a long time in the following. Excessive water during the preparation of PVA gel is separated by filtration. If the PVA gel is too concentrated, water or other liquid medium is optionally added to make up a solution with desired PVA gel concentration.

In the preferred embodiment, the tire sealant prepared in the second method comprises of opaque PVA which functions as an essential sealing component. During its preparation, 0.05%-10% of PVA is firstly dissolved in hot water with rising temperature. After that, the hot water is heated for a long time to form some dissolved PVA. Subsequently, 1%-10% of additives like sodium silicate and borax are added into the dissolved PVA for the formation of opaque PVA gel. If the PVA gel is too concentrated, water or other liquid medium is optionally added to make up a solution with desired PVA gel concentration. The size of the PVA gel is optionally reduced by applying shearing force.

In the preferred embodiment, natural material such as chitosan is also used as a gel material through its dissolution at acidic condition and precipitation by usage of alkali. The re-precipitated chitosan is also used as the flexible gel for sealing purpose. More specifically, 0.01%-5% of chitosan gel material together with 0.05%-10% of PVA gel material in the tire sealant enhances the sealing performance significantly. In order to eliminate the blockage of the valve core while injecting the tire sealant into the tire, the sizes of the flexible PVA gel and the chitosan gel are reduced by conventional grinding, milling or shearing.

In the preferred embodiment, latex is optionally added to further improve the sealing performance of the tire sealant in the present invention despite of its above-mentioned drawbacks.

Rigid particles, preferably bio-degradable chitosan, are added into the tire sealant to improve its sealing performance. The rigid particles with the size of less than 350 microns and with the content of 0.01%-5% can enhance the sealing performance of the tire sealant without causing a blockage problem to the valve core of the tire.

The rigid particles can accumulate in the puncture based on the log-jam mechanism. Thereafter, the jammed particles are combined with the soft and flexible chitosan material and PVA gel particles to form a plug so as to provide higher sealing performance to the puncture. Since the soft and flexible chitosan and the rigid chitosan are from the same source, their compatibility in the sealing mechanism is very excellent.

The rigid particle in the tire sealant is not limited to the chitosan material. Instead, other rigid particles with the size ranging from 0.1 micron to 300 microns can also be used in this embodiment. In the following examples, 0.01%-4% of koalinite, silicon dioxide, wollatonite, diatomite, mica, mesoporous silica and/or colloidal silica are used for tire sealant preparation. Although the rigid particle with higher density can be used, the rigid particle is preferably to have a specific gravity lower than 1.5 to prevent itself from quick precipitation. Furthermore, 0%-3% of bentonite is used to prevent the occurrence of precipitation and sedimentation problems in the tire sealant.

The viscosity of the aqueous suspension can be adjusted by adding the tackifier. Specifically, the amount of tackifier to be added is in the range of 0.1%-10% depending on specific components in usage and a targeted viscosity. Herein, the viscosity of the tire sealant is in the range of 20-10,000 mPa·S and its pH value is between 7 and 10. Precipitation is almost absent in the tire sealant owing to the presence of flexible PVA gel, chitosan gel particles, tackifier and bentonite. Meanwhile, there is no noxious smell for the tire sealant and its sealing performance can be maintained for more than 5 years because of the presence of preservatives.

During operation, the tire sealant can be injected into the tire through a hose under high pressure which is preferably 3-7 bar without removing the valve core. When there is no puncture, the liquid tire sealant is maintained in a mixed state in the rotating tire without any significant physical and chemical changes. In addition, the tire sealant is able to spread inside the tire efficiently so that the puncture occurred at a tire shoulder area can also be sealed.

A sealing performance test is carried out by injecting the prepared tire sealant of 300-450 ml into an aged tire through a hose under a high pressure of 3-7 bar without removing the valve core. It is worth noting that the volume of injected tire sealant can be less than 300 ml depending on the size of the tire to be sealed. However, this value is used as a benchmark in such test. The tire is then rotated by special-designed machine for 5 minutes. A puncture is made on the tire using a typical spike with a diameter of 6.35 mm before or during the rotation. Spikes with other sizes can also be used for the test. Subsequently, the tire is kept rotating for another 5 minutes at 500 rpm with being pressed onto a metal plate to simulate the weight loaded on the tire in reality. The tire is kept stationary with the puncture location pointing upwards. Air leakage from the puncture is checked every hour by adding soap solution. After passing the test, the sealing performance is confirmed by actual road test of vehicles.

In the process of conducting a road test by using the vehicle, the sealing performance is confirmed by injecting the prepared sealant of 300-450 ml into an aged tire through a hose under a high pressure of 3-7 bar without removing the valve core. This road test is completed between −40□ and 70═. After that, a puncture is created at a tread or an edge area of tire shoulder by usage of a typical spike with a diameter of 6.35 mm before the vehicle starts to run on the road. At the beginning of the test, the pressure of the tire is examined to be 2.5 bar. The inner pressure of the tire is monitored at different time intervals to obtain the leakage rate. It is mentioned that the temperature of the tire is also needed to be recorded. The pressure change can represent the performance of the tire sealant, i.e. when the tire sealant has sealed the puncture, negligible pressure change is recorded. The tested tire is still needed to be stored for 24 hours after the vehicle test. In this case, the pressure, temperature, and sealing performance are respectively recorded after the tire has been stored for one and twenty-four hours. Pressure of the tire is also recorded at the end of the storage period.

Hereinafter, a few embodiments of the present invention are described in detail. However, the present invention is not limited to these embodiments.

### EMBODIMENT 1

G2-1227-C

A tire sealant A is consisted of 0.05%-1% of PVA, 0.01%-0.1% of SDS, 10%-40% of water and 0.02%-3% of re-precipitated chitosan, 55%-65% of propylene glycol and 5%-20% of glycerin. In order to avoid foam formation and oxidation, 0.02%-1% of anti-foaming agent and 0.02%-1% of antioxidant are added. The sizes of the flexible PVA gel and the re-precipitated chitosan are reduced by shearing. The viscosity of the preferred tire sealant is in the range of 20-500 mPa·s and the pH value of the tire sealant is between 7 and 10. The tire sealant is able to seal a puncture created by a spike with a diameter of 6.35 mm for 48 hours. The tire sealant is capable of sealing the punctures between −40□ and 70□. Moreover, only little precipitation is formed after the tire sealant is remained for more than one week.

### EMBODIMENT 2

G2-1227-D

A tire sealant B is consisted of 0.05%-1% of PVA, 0.01%-0.1% of SDS, 10%-40% of water and 0.02%-3% of re-precipitated chitosan, 30%-40% of propylene glycol and 5%-20% of glycerin. In order to avoid foam formation and oxidation, 0.02%-1% of anti-foaming agent and 0.02%-1% of antioxidant are added. The sizes of the flexible PVA gel and the re-precipitated chitosan are reduced by shearing. The viscosity of the preferred tire sealant is in the range of 20-500 mPa·s and the pH value of the tire sealant is between 7 and 10. The tire sealant is able to seal a puncture created by a spike with a diameter of 6.35 mm for 48 hours. The tire sealant is capable of sealing the puncture between −40□ and 70□. Moreover, only little precipitation is formed after the tire sealant is remained for more than 1 week.

### EMBODIMENT 3

G2-1233-G

A tire sealant C is consisted of 0.05%-1% of grinded PVA which can pass through 60 mesh filter, 0.01%-0.1% of SDS, 10%-40% of water and 0.02%-3% of re-precipitated chitosan, 55%-65% of propylene glycol and 5%-20% of glycerin. The sizes of the flexible PVA gel and the re-precipitated chitosan are reduced by shearing. In order to avoid foam formation and oxidation, 0.02%-1% of anti-foaming agent and 0.02%-1% of antioxidant are added. The viscosity of the preferred tire sealant is in the range of 20-10000 mPa·s and the pH value of the tire sealant is between 7 and 10. The tire sealant is able to seal a puncture created by a spike with a diameter of 6.35 mm for 48 hours. The tire sealant is capable of sealing the puncture between −40□ and 70□. Moreover, only little precipitation is formed after the tire sealant is remained for more than 1 week.

### EMBODIMENT 4

G3-1

A tire sealant D is consisted of 1%-10% of dissolved PVA, 2%-4% of sodium silicate, 10%-40% of water and 0.02%-3% of chitosan, 55%-65% of propylene glycol and 5%-20% of glycerin. The sizes of the flexible PVA gel and the re-precipitated chitosan are reduced by shearing. In order to avoid foam formation and oxidation, 0.02%-1% of anti-foaming agent and 0.02%-1% of antioxidant are added. The viscosity of the preferred tire sealant is in the range of 20-10000 mPa·s and the pH value of the tire sealant is between 7 and 10. The tire sealant is able to seal a puncture created by a spike with a diameter of 6.35 mm for 48 hours. The tire sealant is capable of sealing the puncture between −40□ and 70□. Moreover, only little precipitation is formed after the tire sealant is remained for more than 1 week.

All mentioned above are only some preferred embodiments of the present invention instead of limiting the present invention. A variety of modification and change can be made to the present invention for the skill in the art. Any of the modification, equivalent and improvement in the spirit and principle of the present invention should be included in the scope of the claims of the present application.

1. A tire sealant, wherein including 35%-95% of solvent, 0.05%-15% of gel, 0.01%-5% of block particles and 0.1%-10% of additive.

2. The tire sealant of claim 1, wherein the gel is comprised of 0.01%-5% of chitosan gel and 0.05%-10% of polyvinyl alcohol gel.

3. The tire sealant of claim 1, wherein the solvent is comprised of 10%-60% of water and 25%-95% of anti-freezing agent.

4. The tire sealant of claim 1, wherein the anti-freezing agent comprises at least one of propylene glycol, glycerin, calcium and magnesium chloride.

5. The tire sealant of claim 1, wherein the block particles comprise at least one of chitosan material, kaolinite, silicon dioxide, wollastonite, diatomite, mica, mesoporous silicon dioxide and colloidal silicon dioxide.

6. The tire sealant of claim 5, wherein a range for particle size of the block particles is 0.1-350 micron.

7. The tire sealant of claim 1, wherein the additive comprises tackifer, preservative, antirusting agent, antifoaming agent, curing agent, colorant and antioxidant.

8. A method for preparing a tire sealant, wherein comprising the following steps:
S1. Dissolving polymer material particles and controlling precipitation to form suspended gel material in a liquid medium;
S2. Adding an additive into the liquid medium; and
S3. Adding block particles into the liquid medium which contains the suspended gel material.

9. The method for preparing the tire sealant of claim 8, wherein the step S1 comprises a step S1a: dissolving polyvinyl alcohol and a proper amount of surfactant into hot water firstly, and then heating the hot water for a long time so as to prepare polyvinyl alcohol gel.

10. The method for preparing the tire sealant of claim 8, wherein the step S1 comprises a step S1b: firstly dissolving polyvinyl alcohol into hot water completely, and then adding a proper amount of the additive to prepare polyvinyl alcohol gel.
